(19) United States
(12) Patent Application Publication
(10) Pub. No.: US 2005/0248597 A1
(43) Pub. Date: Nov. 10, 2005

(54) Data stream reference to external resources

(76) Inventors: William C. Kuhn, Kettering, OH (US); Michael C. Robbeloth, Carlisle, OH (US)

Correspondence Address: Mark G. Bocchetti;Patent Legal Staff, Eastman Kodak Company, 343 State Street, Rochester, NY, 14650-2201, US

(21) Appl. No.: 10/839,463

(22) Filed: May 5, 2004

(51) Int. Cl. B41J 29/38

(52) U.S. Cl. 347/5

(57) ABSTRACT

A method for modifying data streams to run faster in a data system for an ink jet printing system entails identifying a source of the data stream and operating the data stream at an initial rate. Large commands sets are identified in the data stream and are extracted from the data stream to reduce the size of the data stream. The large commands sets are placed in a secondary storage and a smaller set of commands is inserted into the data stream with new commands to replace the large sets so the data stream operates at a faster rate. Alternative methods include methods for modifying data streams to run faster in a data system for a printing system and methods for modifying potential data streams to run faster in a data system for a printing system.

### CROSS REFERENCE TO RELATED APPLICATIONS

### FIELD OF THE INVENTION

The present embodiments relate to a data format and a method of processing data that enables faster ink jet printing of a data stream.

### BACKGROUND OF THE INVENTION

A need exists in the ink jet printing industry for faster printing. Customers have data in data streams that are too large to print quickly. As the demand for multicolor imaging has increased, the need for faster printing capabilities has also increased.

Current hardware does not support with memory the tasks that need printing. Accordingly, a need exists to use customers' existing data streams but to modify them to run faster while keeping access to any code that has been extracted.

Similarly, a need exists for an imaging data system that can access large bitmap images at speeds faster than those using inline bitmaps.

The present embodiments described herein were designed to meet these needs.

### SUMMARY OF THE INVENTION

A method for modifying data streams to run faster in a data system for a printing system begins by identifying the source of the data stream and operating the data stream at a first rate. A large set of commands are identified and extracted from the data stream to reduce the size of the data stream. The large set of commands is placed in a secondary storage, and a smaller set of commands is inserted into the data stream. The smaller set of commands includes hew commands. The data stream now operates at a rate faster than the first rate.

A method for modifying data streams to run faster in a data system for a printing system entails replacing a small set of commands for the large set of commands, forming a modified data stream with new commands. The modified data stream operates at a faster rate than the data stream with the larger set of commands. Instructions are provided to the source to form additional data streams based on the new commands without the large set of commands.

A method for modifying potential data streams to run faster in a data system for a printing system includes identifying a source of a potential data stream operating at a first rate. The large set of commands is identified in the potential data stream. A real data stream is created from the potential data stream by inserting a smaller set of commands for the large set of commands. The real data stream operates at rate faster than the rate of the potential data stream. The large set of commands is placed into a secondary storage.

### BRIEF DESCRIPTION OF THE DRAWINGS

In the detailed description of the preferred embodiments presented below, reference is made to the accompanying drawings, in which:

FIG. 1 depicts a block diagram of an embodied method for modifying data streams to run faster in a data system for a printing system.

FIG. 2 depicts a block diagram of an embodied method for modifying data streams to run faster in a data system for a printing system.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The methods were created because of a need for smaller data streams for ink jet printing systems that, in turn, run faster than current data streams.

The methods are not only usable to modify existing data streams from a larger to a smaller size, but also usable to create different data streams prior running a potential data stream so that the actual or resulting usable data stream is smaller and faster without wasting time and money running the more awkward stream.

Another embodiment of the method includes the step of notifying a customer after an actual data stream has been modified, so that the customer can, in turn, create additional data streams similar to the modified data stream.

Part of the inventive method involves moving sets of commands to a secondary storage, so that these sets of commands, referred to later as “large sets of commands”, are retrievably stored and reusable. By making the sets of commands relocatable, the method saves time and money. This recycling advantage saves the substantial cost of creating other “large sets of commands” for data streams by embedding location markers in the modified data stream as to the location of the removed large sets of commands.

The embodied methods additionally add versatility and flexibility to current ink jet printing systems because the data stream can dynamically be pointed to an alternate secondary storage of commands, in case there is a need to use the feature or functionality of the commands in the alternate secondary storage. The information that has been externally stored in the secondary storage can be easily and readily replaced with new information from yet another source, for ease of incorporation of new data into the data stream.

The embodied methods relate to software usable in inkjet printing systems.

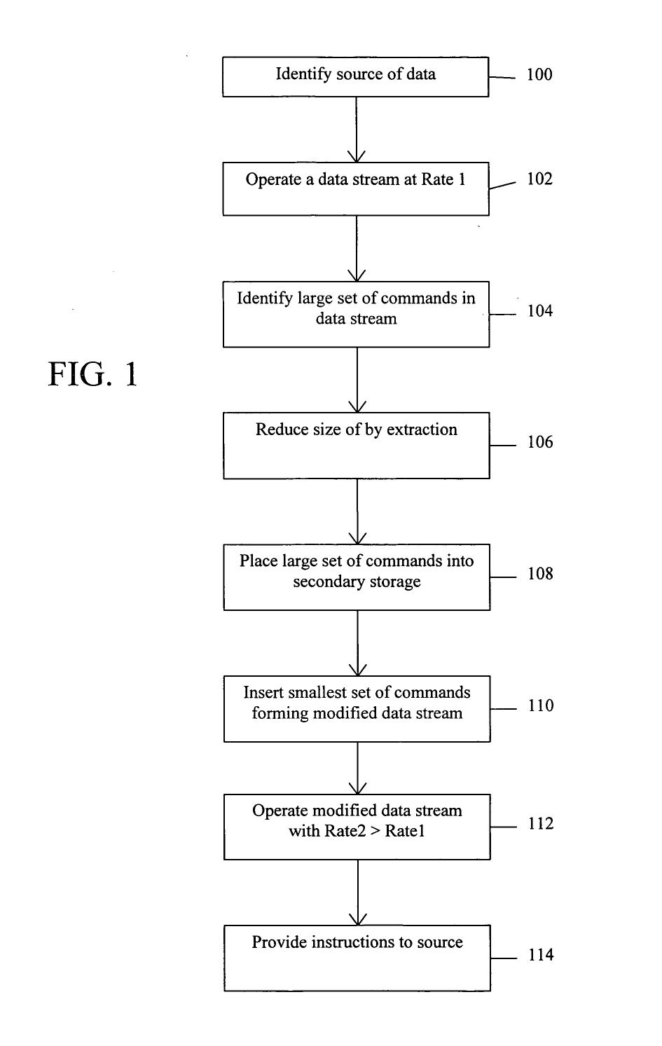

With reference to the figures, FIG. 1 depicts a block diagram of a method for modifying data streams to run faster in a data system for an inkjet printing system. The method includes identifying a source of the data stream (Step 100), operating the data stream at a first rate (Step 102), identifying a large set of commands in the data stream (Step 104), and reducing the size of the data stream by extracting the large set of commands from the data stream (Step 106). The method continues by placing the large set of commands into a secondary storage (Step 108) and replacing the large set of commands with a small set of commands forming a modified data stream with the small set of commands (Step 110). The small set of commands can be termed “new commands” herein. The 30 method ends by operating the modified data stream at a second rate (Step 112) that is faster than the first rate (Step 102) of the data stream. An example of an ink jet print station is a Kodak Versamark DT92 print station available from Kodak Versamark of Dayton, Ohio.

As an additional step in a second embodiment, instructions can be provided to the source to form additional data streams based on the new commands without the large set of commands, and operate at a second rate faster than the first rate (Step 114).

The large set of commands is extracted using a filter. The large set of commands refers to thousands or millions of bytes of commands. The small set of commands refers to tens or hundreds of bytes of commands.

The commands include set up commands, font commands, fixed file commands, document commands, end of job command, and combinations thereof. A set up command can be “Printhead Requirement” (PHR). An exemplary font command can be “Font Definition Record” (FDR). An exemplary fixed file command is “Load Fixed File 10” (LFF10). An example of a document command can be “Start of Document and wait for Cue” (SDC).

The document commands include page control commands, image control commands, and image data commands, and combinations thereof. A page control command can be the command “Set Origin” (SO). An image control command can be “Set Position” (SPO). An image data command can be “Image A-Line” (IML).

The page control command includes start page commands, start of document commands, go to fixed file commands, and combinations thereof. A start page command can be “Start of Page” (SOP). A start of document command can be “Start of Document” (SOD). A go to fixed file command can be “Go to Fixed File” (GFF).

The image control commands include set position, set logical function, set font commands, and combinations thereof. An image control command to set position can be “Set Logical Function” (SLF). An image control set font command can be “Set Font” (SF).

The image data commands include image bitmap, image a line (IML), and combinations thereof. An example of an image data command for an image bitmap can be “Image Bitmap” (IBM). An example of an image a line code can be “Set Font and Image” (SFI).

The fixed file commands include multiple load fixed file commands and an end fixed file command. An exemplary multiple load fixed file command can be “”Load Fixed File” (LFF). An exemplary end fixed file command can be “End Fixed File” (EFF).

The setup commands include commands to indicate job title, page set up, type of print head required, number of print heads, print head stitching, font requirements, and combinations thereof. An exemplary command to indicate job title can be “Job Control Record” (JCR). An example for a page set up command can be “Page Length Requirement” (PLR). An exemplary type of print head required command can be “Four-inch print head” (PH4). A command that can indicate the number of print heads can be “Ten print heads” (10PH). A command for print head stitching can be “Construct logical Print Head 1 from Print Heads 1 & 2” (JCR2). An exemplary font requirement command can be the “Font Assignment Record” (FAR).

The font commands include commands to font definition commands, character definition commands, and combinations thereof. These types of commands indicate the number of fonts, the number of font characters, the orientation and size of the font characters, and names of the fonts.

Font definition commands include super font definitions, font metrics, standard font definition, and combinations thereof. The font definition command includes bitmaps. The character definition commands can be: standard character definitions with bitmaps, compressed character definitions with bitmaps, and character definitions with character metrics with bitmaps.

A first example of the method for modifying data streams to run faster in a data system for a printing system involves taking an existing data stream called homiunc.ijp and filtering that data stream.

The existing data stream contains a series of satellite bitmap images that cannot be converted into font characters within the memory capacities on our printers to facilitate high performance printing. As such, the satellite images are stored in the data stream as inline bitmaps. Attempting to print this data stream is too slow for typical data systems in comparison to the requirements of typical customers.

A source of data is identified, such as the data stream homiunc.ijp (Step 100). The data stream is operated upon by a data system at the first rate (Step 102). The performance at the first rate is found to be insufficient to meet the customer's requirements.

Subsequently, a large set of commands is identified in the data stream such that, if they are removed, reduce the size of the original data stream and increase the performance to a second data rate faster than the first data rate (Step 104). In the case of homiunc.ijp, multiple sets of image bitmap commands from the document commands are removed and placed into secondary storage (Step 106 and Step 108).

To facilitate the extraction of these sets of commands, an object filter called “jobfilthomiunc” is compiled and linked from a source filter “jobfilthomiunc.c”. The object filter, “jobfilthomiuncrs” receives as input the data stream homiunc.ijp, whereby each set of image bitmap commands is recognized and extracted into its own container file for placement into secondary storage. Specifically, the object filter extracts all image bitmap commands from the data stream homiunc.ijp that occurs between two start page commands and places them into the container file imageₙ, where n corresponds to the document number attribute of the first start page command.

The set of container files are moved into a secondary storage device for later processing by the data system, as specified in the data stream corresponding to the second faster rate. The files can be moved by the use of a suite of networking protocols or through encoding onto an optical or magnetic media source to be physically moved to the system from which the data system will retrieve such files. In the example, the container files image₁, image₂, image₃, . . . , imageₙ, are encoded onto optical media in a optical drive and then are transferred by placement of the optical media into the optical drive of the data system where such container files are then copied onto the set of magnetic devices that make up the Redundant Array of Inexpensive Disks (RAID).

In addition to the extraction of the image bitmap commands, the object filter “jobfilthomiunc” creates a new modified data stream homiuncrs.ijp that contains all the commands from the original data stream homiunc.ijp without the extracted image bitmap commands (Step 110). The new modified data stream homiuncrs.ijp contains the smaller set of external resource commands inserted into the data stream in place of the large set of image bitmap commands. The external resource commands help the data system to identify the different names of the container files.

The modified data stream homiuncrs.ijp is given as input to the data system where the stream operates at a faster rate (Step 112). Whenever the data system encounters the extracted resource command, the stream forms additional data streams by finding the named container file, and then reads the extracted commands for processing as if the commands were part of one contiguous data stream. The reduction in the size of the homiunc.ijp data stream comes from removing 55,000 image bitmap commands with a total size of 197,017,600 bytes with 100 external resource commands with a total size of 2200 bytes in a data stream called homiuncrs.ijp.

As an additional benefit, the filter can be extended to insert the small set of external resource commands for several, additional times so as to permit the copying of the satellite images without creating any additional container files. For example, the same set of container files can be reused repeatedly, freeing the user from the need to have a third party make multiple copies of the data stream. The recognized cost is only an increase of 2200 bytes in the inline data stream for each set of copies made of the satellite images by the printer.

A second example of a method for modifying data streams to run faster in a data system for a printing system involves, initially, informing a customer about the ability to eliminate the redundant use of a large set of commands within a data stream that constitutes some set of document images. The existing data stream contains a sample of a series of stock prospectuses for a number of different clients, stored as compressed bitmap images. These images cannot be converted into font characters within the memory capacities on typical printers to facilitate high performance printing. As such, the stock prospectuses are stored in the data stream as inline compressed bitmaps. Attempting to print this data stream is too slow in typical data systems in comparison to the requirements of our customers.

The customer identifies a data stream source (Step 100), such as a sample data stream consisting of a stock prospectus for a number of different clients. The prospectus contains information about particular investments that are owned by some portion of those clients. The customer operates a data system on this data stream (Step 102) and finds that the first rate performance of the system does not permit the distribution of the prospectus information to the customer's clients in a timely manner.

Instead of repeating the same information on a particular investment for a number of different clients within the data stream, the client is informed that the information could be extracted and placed into a container file for later retrieval by a data stream, as specified by a newly created or modified input data stream.

The customer identifies the large set of commands in the data stream (Step 104) that occurs multiple times for a particular investment, and then uses proprietary tools to extract the large set of commands into a container file called investments where investments is the name of the commonly recurring investment. The extraction process effectively reduces the size of the data stream (Step 106) once the large set of commands in the original data stream are replaced by the small set of commands.

The container files are then transferred into secondary storage (Step108) from the location where the proprietary tools created and placed them into a set of magnetic devices that make up the Redundant Array of Inexpensive Disks (RAID) on the data system. The medium that is used to transfer the container files is the file transfer protocol (FTP), and requires a FTP server running on a data system and a FTP client running on some other system to access the container files.

The customer uses some proprietary tool to modify the original data stream so that a small set of external resource commands are inserted in place of the large sets of commands in the final data stream at the appropriate locations (Step 110). The modification of the original data stream results in the creation of a final data stream. When the final data stream is operated on by the data system, the performance of the final data stream corresponds to the second and faster rate.

The data system operates on the final data stream at a second rate faster than the first rate (Step 112). Within the final data stream, external resource commands provide instructions on how to reconstruct the existing data stream by opening specific container files with the large sets of extracted commands, and then how to read those commands for processing as if they were part of one contiguous data stream.

The customer then uses the knowledge that the modified data stream operates at a second data rate faster than the first data rate to construct similar, but additional data streams (Step 114).

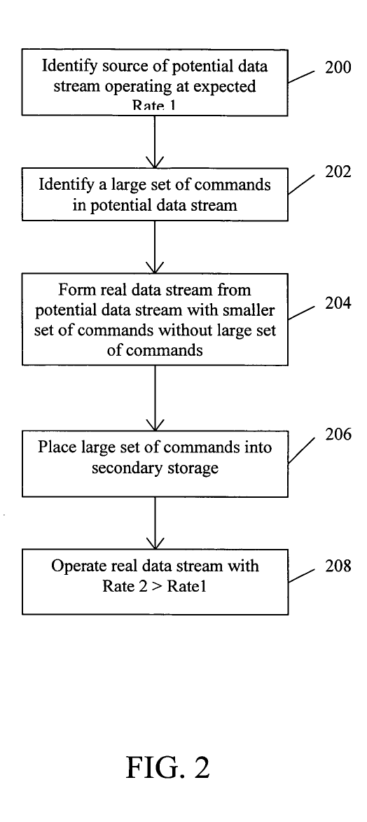

FIG. 2 depicts a block diagram illustrating the method for modifying potential data streams to run faster in a data system for an inkjet printing system including the step of identifying a source of a potential data stream (Step 200) wherein the potential data stream can operate at a potential first rate. Next, a large set of commands in the potential data stream (Step 202), is identified. Then a data stream intended for actual use, herein “real data stream”, is made from the potential data stream with the smaller set of commands instead of the identified large set of commands (Step 204). The large set of commands is placed into a secondary storage (Step 206). Then the real data stream is operated at a second rate faster than the potential first rate of the potential data stream (Step 208).

The secondary storage is an optical storage device, fixed or removable magnetic storage device, a network attached storage device, a server, a RAID or combinations thereof. The data stream is an ink jet printer data stream.

The following is an example of a method for modifying potential data streams to run faster in a data system for a printing system. In this example, the customer decides to use proprietary tools to create a stock prospectus data stream for actual distribution to clients. The proposed data stream will contain the entire set of a series of stock prospectuses for a number of different clients stored as compressed bitmap images. These images cannot be converted into font characters within the memory capacities on typical printers to facilitate high performance printing. As such, the stock prospectuses are stored in the data stream as inline compressed bitmaps. Attempting to print this data stream is too slow on typical data systems in comparison to the requirements of the customer.

The resulting potential data stream, which can be far larger than the previous original data stream prior to the extraction of a large set of commands, can be operated on by a data system at a first rate (Step 200). Large sets of commands in the potential data stream corresponding to a particular investment are identified (Step 202) and placed into a container file called investments where investment, is the name of the commonly recurring investment. In this example, the large set of commands is not extracted from some preexisting data stream, but is created by some means through tools and placed directly into some container file.

The customer uses the proprietary tools to create a real data stream from the potential data stream and then inserts the smaller set of commands without the large set of commands (Step 204). The container files are transferred from the location where the proprietary tools created them into secondary storage (Step 206). The secondary storage is made up of a set of magnetic devices known as a Redundant Array of Inexpensive Disks (RAID) on the data system. The medium that is used to transfer the container files is the file transfer protocol (FTP) and requires a FTP server running on a data system and a FTP client running on some other system with access to the container files.

The real data stream is then operated on by the data stream at a second rate faster than the potential first rate (Step 208). Within the real data stream, external resource commands provide instructions on how to construct the data streams by opening specific container files with the large sets of extracted commands, and how to read those commands for processing as if they were part of one contiguous data stream.

The embodiments have been described in detail with particular reference to certain preferred embodiments thereof, but it will be understood that variations and modifications can be effected within the scope of the embodiments, especially to those skilled in the art.

### PARTS LIST

100. step—identifying source of data.
102. step—operate a data stream at first rate.
104. step—identify large set of commands in data stream.
106. step—reduce size of extraction.
108. step—place large set of commands into secondary storage.
110. step—insert smaller set of commands forming modified data steam.
112. step—operate modified data stream with a second rate greater than first rate.
114. step—provide instructions to source.
200. step—identify source of potential data stream operating at first rate.
202. step—identify a large set of commands in potential data stream.
204. step—form real data stream from potential data stream with smaller set, of commands without large set of commands.
206. step—placing large set of commands into secondary storage.
208. step—operate real data stream with second rate greater than first rate.

1. A method for modifying data streams to run faster in a data system for an ink jet printing system, wherein the method comprises the steps of:
a. identifying a source of the data stream;
b. operating the data stream at a first rate;
c. identifying a large set of commands in the data stream;
d. reducing the size of the data stream by extracting the large set of commands from the data stream;
e. placing the large set of commands into a secondary storage;
f. inserting a smaller set of commands in place of the large set of commands forming a modified data stream with the smaller set of commands; and
g. operating the modified data stream at a second rate faster than the rate of the first data stream.

2. The method of claim 1, further comprising the step of extracting the large set of commands using a filter.

3. The method of claim 1, wherein the secondary storage is an optical storage device, fixed or removable magnetic storage device, a network attached storage device, a server, a redundant array of inexpensive disks (RAID), or combinations thereof.

4. The method of claim 1, wherein the commands comprise set up commands, font commands, fixed file commands, document commands, and end of job command, and combinations thereof.

5. The method of claim 4, wherein the document commands comprise page control commands, image control commands, and image data commands, and combinations thereof.

6. The method of claim 5, wherein the page control command comprise start page commands, start of document commands, go to fixed file commands, and combinations thereof.

7. The method of claim 5, wherein the image control commands comprise set position, set logical function, set font commands, and combinations thereof.

8. The method of claim 5, wherein the image data commands comprise image bitmap, image a line (IML), and combinations thereof.

9. The method of claim 4, wherein the setup commands comprise commands to indicate job title, page set up, type of print head required, number of print heads, print head stitching, fonts requirements, and combinations thereof.

10. The method of claim 4, wherein the font commands comprise commands to font definition commands, character definition commands, and combinations thereof.

11. The method of claim 10, wherein the font definition commands comprise super font definition, font metrics, standard front definition, and combinations thereof.

12. The method of claim 10, wherein the character definition commands comprise standard character definitions with bitmaps, compressed character definitions with bitmaps, character definitions with character metrics with bitmaps.

13. The method of claim 4, wherein the fixed file commands comprise multiple load fixed file commands, end fixed file commands, and wherein fixed file commands can link to other commands, can control other commands or include fixed files consisting of commands and combinations thereof.

14. A method for modifying data streams to run faster in a data system for an ink jet printing system, wherein the method comprises the steps of:
a. identifying a source of a data stream;
b. operating the data stream at a first rate;
c. identifying a large set of commands in the data stream;
d. reducing the size of the data stream by extracting the large set of commands from the data stream;
e. placing the large set of commands into a secondary storage;
f. replacing a small set of commands for the large set of commands forming a modified data stream with the small set of commands;
g. operating the modified data stream at a second rate faster than the rate of the first data stream; and
h. providing instructions to the source to form additional data streams based on the small set of commands without the large set of commands, wherein the second rate is faster than the first rate.

15. The method of claim 14, wherein the large set of commands is extracted using removing is using a filter.

16. The method of claim 14, wherein the secondary storage is an optical storage device, fixed or removable magnetic storage device, a network attached storage device, a server, a redundant array of inexpensive disks (RAID), or combinations thereof.

17. The method of claim 14, wherein the commands comprise set up commands, font commands, fixed file commands, document commands, and end of job command, and combinations thereof.

18. The method of claim 17, wherein the document commands comprise page control commands, image control commands, and image data commands, and combinations thereof.

19. The method of claim 18, wherein the page control command comprise start page commands, start of document commands, go to fixed file commands, and combinations thereof.

20. The method of claim 18, wherein the image control commands comprise set position, set logical function, set font commands, and combinations thereof.

21. The method of claim 18, wherein the image data commands comprise image bitmap, image a line (IML), and combinations thereof.

22. The method of claim 17, wherein the setup commands comprise commands to indicate job title, page set up, type of print head required, number of print heads, print head stitching, fonts requirements, and combinations thereof.

23. The method of claim 17, wherein the font commands comprise commands to font definition commands, character definition commands, and combinations thereof.

24. The method of claim 23, wherein the font definition commands comprise super font definition, font metrics, standard front definition, and combinations thereof.

25. The method of claim 23, wherein the character definition commands comprise standard character definitions with bitmaps, compressed character definitions with bitmaps, character definitions with character metrics with bitmaps.

26. The method of claim 17, wherein the fixed file commands comprise multiple load fixed file commands, end fixed file commands, and wherein fixed file commands can link to other commands, can control other commands or include fixed files consisting of commands and combinations thereof.

27. A method for modifying potential data streams to run faster in a data system for an ink jet printing system, wherein the method comprises the steps of:
a. identifying a source of a potential data stream wherein the potential data stream is expected to operate at a first rate;
b. identifying a large set of commands in the potential data stream;
c. forming a real data stream from the potential data stream with a smaller set of commands without the identified large set of commands;
d. placing the large set of commands into a secondary storage; and
e. operating the real data stream at a second rate faster than the expected first rate.

28. The method of claim 27, wherein the secondary storage is an optical storage device, fixed or removable magnetic storage device, a network attached storage device, a server, a redundant array of inexpensive disks (RAID), or combinations thereof.

29. The method of claim 27, wherein the commands comprise set up commands, font commands, fixed file commands, document commands, and end of job command, and combinations thereof.

30. The method of claim 29, wherein the document commands comprise page control commands, image control commands, and image data commands, and combinations thereof.

31. The method of claim 30, wherein the page control command comprise start page commands, start of document commands, go to fixed file commands, and combinations thereof.

32. The method of claim 30, wherein the image control commands comprise set position, set logical function, set font commands, and combinations thereof.

33. The method of claim 30, wherein the image data commands comprise image bitmap, image a line (IML), and combinations thereof.

34. The method of claim 29, wherein the setup commands comprise commands to indicate job title, page set up, type of print head required, number of print heads, print head stitching, fonts requirements, and combinations thereof.

35. The method of claim 29, wherein the font commands comprise commands to font definition commands, character definition commands, and combinations thereof.

36. The method of claim 35, wherein the font definition commands comprise super font definition, font metrics, standard front definition, and combinations thereof.

37. The method of claim 35, wherein the character definition commands comprise standard character definitions with bitmaps, compressed character definitions with bitmaps, character definitions with character metrics with bitmaps.

38. The method of claim 29, wherein the fixed file commands comprise multiple load fixed file commands, end fixed file commands, and wherein fixed file commands can link to other commands, can control other commands or include fixed files consisting of commands and combinations thereof.
